(19) United States
(12) Patent Application Publication
(10) Pub. No.: US 2022/0037946 A1
(43) Pub. Date: Feb. 3, 2022

(54) COOLING CHANNEL FOR A WINDING OVERHANG OF AN ELECTRICAL MACHINE

(71) Applicant: JHEECO E-DRIVE AG, Eschen (LI)

(72) Inventors: Markus MICHAEL, Altstätten (CH); Martin STÖCK, Salez (CH)

(21) Appl. No.: 17/312,330

(22) PCT Filed: Dec. 11, 2019
(86) PCT No.: PCT/EP2019/084748

§ 371 Date: Jun. 9, 2021

(30) Foreign Application Priority Data
Dec. 12, 2018 (DE) 10 2018 131 961.4

(51) Int. Cl. H02K 3/24; H02K 9/19; H02K 5/20

(52) U.S. Cl. CPC H02K 3/24; H02K 5/20; H02K 9/19

(57) ABSTRACT

The invention relates to a cooling channel for a winding overhang of an electrical machine, wherein, in order to conduct a cooling fluid, said cooling channel is designed with at least one inflow and at least one outflow and is annular for provision around the winding overhang. The cooling channel has a plurality of partitions arranged such that parallel sub-channels are formed between the at least one inflow and at least one outflow, and the inflow is arranged radially outwardly, relative to the cooling channel, and the outflow radially inwardly, or vice versa.

The invention relates to a cooling channel for a winding head of an electrical machine as well as to a stator with such a cooling channel.

The term “electrical machine” is essentially to be understood as an electric motor or an electric generator having a stator and a rotor, the rotor being rotatably mounted relative to the stator about a common central axis. The stator comprises a stator core stack and a current-carrying winding. The winding is preferably arranged in grooves of the stator core stack extending axially distributed across the circumference. The winding forms a plurality of coils/half coils, wherein one coil/half coil comprises two conductor sections extending in different grooves and two/one connecting sections connecting these conductor sections at the end side of the stator core stack. Only the winding portion extending axially within a groove contributes to the torque; it is also referred to as the active length. In contrast, those parts of the winding which electrically connect the active lengths at the front ends of the core stack are torque-blind; this part located axially outside the core stack is also referred to as winding head. A winding head can consequently be considered as that part of a winding axially projecting from the stator core stack.

A plurality of conductor sections can be placed within one groove (multilayer system).

As temperature rises, the efficiency of electrical machines, in particular of traction motors for electric vehicles, decreases which is why the electrical machines are cooled by means of a cooling fluid, as is well known. This is accomplished e. g. via a cooling sleeve/channel or cooling jacket through which water flows and which indirectly cools a stator or its stator jacket. Indirect cooling means that the cooling fluid and the heat source are not in direct contact. To increase efficiency, it is furthermore known to directly cool winding heads. Here, in most cases, a dielectric oil is employed which is pumped through the winding head.

US 2017 310 189 describes a winding head cooling in the form of a cooling cap for electric motors.

DE 10 2015 220 112 A1 describes a cover unit for a winding head of an electrical machine, wherein the cover unit comprises a cooling channel which extends along the circumferential direction of the stator.

It is furthermore known that a winding can also be composed of bar-type conductors which are inserted into or pulled through grooves of a core stack.

The bar-type conductors are connected in pairs into half coils. This can be done directly, for example by bending the bar-type conductors towards each other and directly welding them, or else indirectly, for example by connection webs bridging the distance between two bar-type conductors (synonym: end connectors).

Bar-type conductors can be embodied in one piece (solid wire) or in multiple pieces (wire strands), and be embodied, for example, in the form of hairpins or in an I-shape (I pins). Bar-type conductors can in particular also be embodied as compression moulded and twisted wire strands.

By means of the winding head, the segment conductors or bar-type conductors arranged within the stator are connected to each other at their ends and according to a predetermined pattern.

For directly connected bar-type conductors, for example hairpin windings, a winding head cooling can be easily realised by placing a cooling cap. For winding heads equipped with connection webs, direct cooling is difficult to realise since the individual connection webs have to be held by holders. In particular for mobile applications, where high vibrations occur, the secure retention of connection webs is at risk. Therefore, connection webs for mobile applications are in most cases placed directly one upon the other and encapsulated by resin. This protects the electric contact from an interruption, for example, by a fatigue fracture in a welded joint due to vibrations, but it involves disadvantages in the cooling of the winding head.

It is thus the object of the present invention to provide a direct and improved cooling for an electrical machine or its winding head, respectively, in particular a winding head equipped with connection webs.

To this end, a cooling channel according to claim 1 is provided according to the invention. In detail, a cooling channel for a winding head of an electrical machine is provided wherein, in order to conduct a cooling fluid, said cooling channel is designed with at least one inflow and at least one outflow and is annular for provision around the winding head. The cooling channel has a plurality of partitions arranged such that parallel sub-channels are formed between the at least one inflow and at least one outflow, and the inflow is arranged radially outwardly, relative to the cooling channel, and the outflow radially inwardly, or the inflow radially inwardly and the outflow radially outwardly. This has the advantage that defined channels are formed by means of the partitions and thus the flow of the cooling fluid describes defined paths. This ensures that all segment conductors are cooled, preferably equally cooled, and thus the efficiency of the electrical machine is increased. Hotspots due to a non-uniform cooling medium distribution can be avoided or reduced, respectively. Equally, defined cooling channels permit a technically advantageous embodiment of the flow. For example, a reduction or increase of swirls of the cooling flow and/or a reduction or increase of the cooling flow speed and/or a reduction or increase of the cooling flow quantity can be influenced. Thereby, the cooling effect of the winding head can be improved.

Parallel sub-channels are to be understood as a fluidic parallel connection, not a geometric parallelism of the sub-channels.

The partitions also permit to serve as a fixing or fastening, respectively, for the connection webs of the winding head, or are preferably designed for this purpose. Here, one or more connection webs are arranged or held between the partitions at a predetermined location and prevented from slipping or shifting. The electric contact between the connection webs and the bar-type conductors of the stator is thereby secured and protected from an interruption, e. g. in case of vibrations.

Preferably, the fluid flow flows from radially outside to radially inside. Thereby, the fluid outlet can optionally coincide with a cooling outlet of a hollow rotor shaft through which a cooling fluid flows.

Preferably, the inflow and/or the outflow are each formed as an annular gap, the inflow and the outflow being separated from each other by an annual top section of the cooling channel. This preferred embodiment has the advantage that a uniform and anywhere continuous inflow and outflow of the cooling fluid for the winding head is permitted.

Preferably, at least some of the plurality of partitions are arranged radially and form radial partitions. Here, the partitions form levels which are parallel to the central axis of the stator. This has the advantage that the connection webs are individually separated from each other and can be held more securely. This is in particular the case if the connection webs are formed of an arc and two radial webs and the webs, are each arranged between two partitions.

It is equally advantageous for at least some of the plurality of partitions to be formed in a circular arc and in particular in groups concentrically with respect to each other. This is in particular advantageous for the connection webs if they comprise a connection arc or are formed in an arch shape. Thereby, the connection webs can be arranged and held at a predetermined location.

It is furthermore advantageous for at least some of the plurality of partitions to comprise and/or form insulation rings arranged concentrically and in parallel—in a geometrical sense—with respect to each other. These insulation rings can be understood as bottom plates for the connection webs in the form of annulus-shaped discs and are in particular arranged perpendicularly to the central axis of the stator or horizontally. These partitions can equally alternatively have a conical lateral area. They help to fluidically and/or electrically separate different connection levels from each other and hold connection webs.

In order to form channels around the connection webs, the radial partitions, the arched partitions, and/or the horizontal partitions (also referred to as insulation rings) can be always, or at least partially, arranged perpendicularly with respect to each other. This will add more mechanical stability to the cooling channel and provide flow paths for the cooling fluid which are better organised.

In order to fix or hold the connection webs within the partitions, these partitions comprise fastening elements, in particular clamping elements or naps. These fastening elements permit the application of the cooling channel for differently shaped or thick connection webs and to thus design them more flexibly. Moreover, the cooling fluid can flow through the distance or space between the partition and the connection web created by the fastening elements in an unobstructed manner and better cool the connection webs.

As an alternative, the connection webs can, however, also be positioned within the partitions loosely, that means with a clearance. This provides clearance for the creation of the electric connection between the connection webs and the bar-type conductors. Tolerance dependencies can thereby be reduced.

Preferably, the plurality of partitions is formed of an elastic and/or an electrically insulating material. Thereby, in particular construction tolerances can be better compensated, and the cooling channel can be altogether more easily attached on the winding head.

The partitions can be connected to each other in the form of tongue-and-groove connections for sealing the cooling channel or parts of the cooling channel. The partitions can alternatively or in addition comprise sealing means, for example sealing lips, for fluidically sealing contacting partitions. Sealing means can be formed as independent components, for example as O-rings, or else as components of a multi-component partition moulded thereto. In particular, sealing means can be provided between partitions or insulation rings horizontally located one upon the other.

In a further advantageous embodiment, the cooling channel is embodied in one or more pieces. A multi-piece channel permits to flexibly design the complete embodiment as required; in this way, the number of partitions and/or outer walls can be adapted and varied depending on the winding head.

It is also advantageous for the cooling channel to comprise a sealing element, in particular a sealing mat, as a bottom component and a stator cooling housing as an outer sidewall. This particular embodiment shows that already existing components of the stator can be used for the cooling channel, and thus additional components for the channel can be omitted.

According to the invention, a stator according to claim 11 is provided. This stator, which is in particular intended for an electric motor, is formed with a plurality of bar-type conductors, wherein the stator comprises at least one cooling channel according to the present invention, and the partitions of the cooling channel are arranged between at least some of the bar-type conductors. In this embodiment, the bar-type conductors reach into the cooling channel and are electrically connected with the connection webs arranged in the cooling channel. In a further embodiment, the connection webs can protrude from the cooling channel and be electrically connected to the bar-type conductors outside the cooling channel.

Preferably, the stator comprises a plurality of connection webs corresponding to the bar-type conductors.

Furthermore, an electrical machine with a cooling channel according to the present invention or a stator as disclosed above is provided according to the invention.

The figures described below relate to preferred embodiments of the cooling channel according to the invention and the stator according to the invention, wherein these figures do not serve as a restriction, but essentially to illustrate the invention. Elements of different figures but having the same reference numerals are identical, therefore, the description of an element of one figure is also applicable for elements of other figures with the same designation or number.

In the drawings:

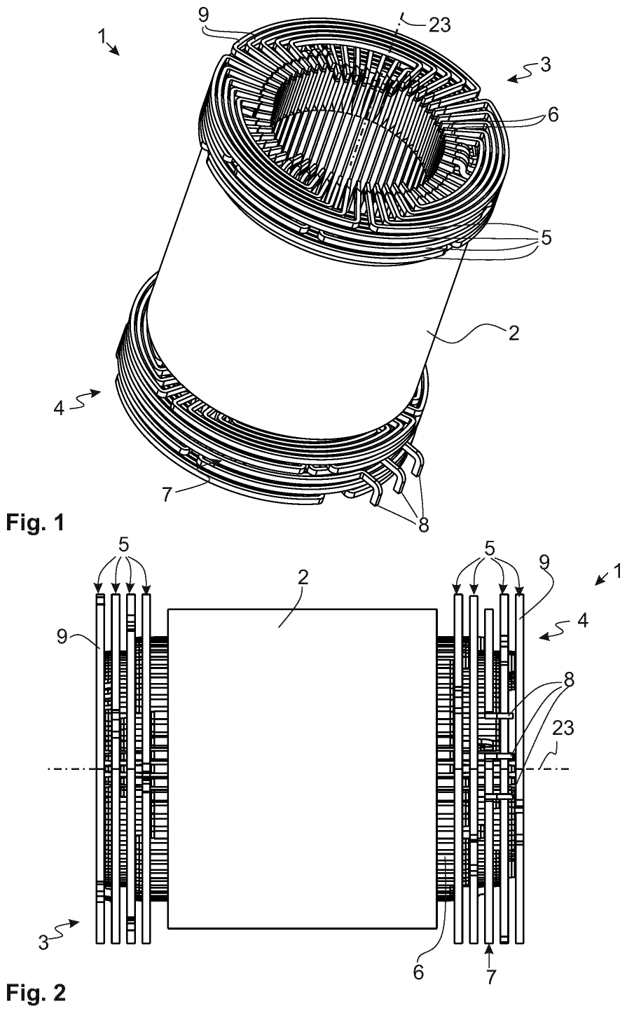

FIG. 1 shows a perspective view of a stator with an assembled winding;

FIG. 2 shows a side view of the stator according to FIG. 1;

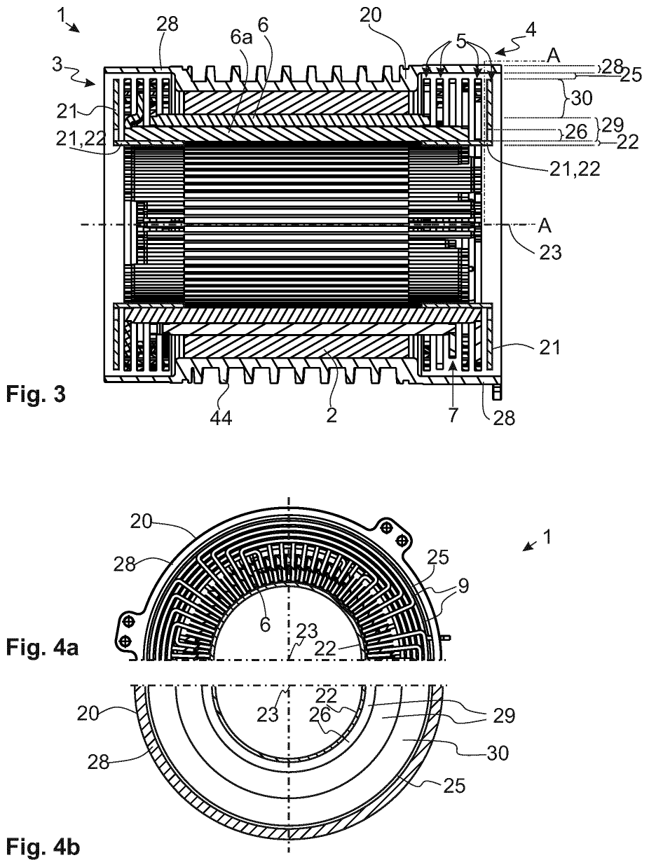

FIG. 3 shows a basic form of a winding head cooling for a stator according to FIGS. 1 and 2;

FIG. 4A shows a cross-section of a stator half according to FIG. 3 on a connection level;

FIG. 4B shows a schematic plan view of a stator half according to FIG. 3 with different ring areas;

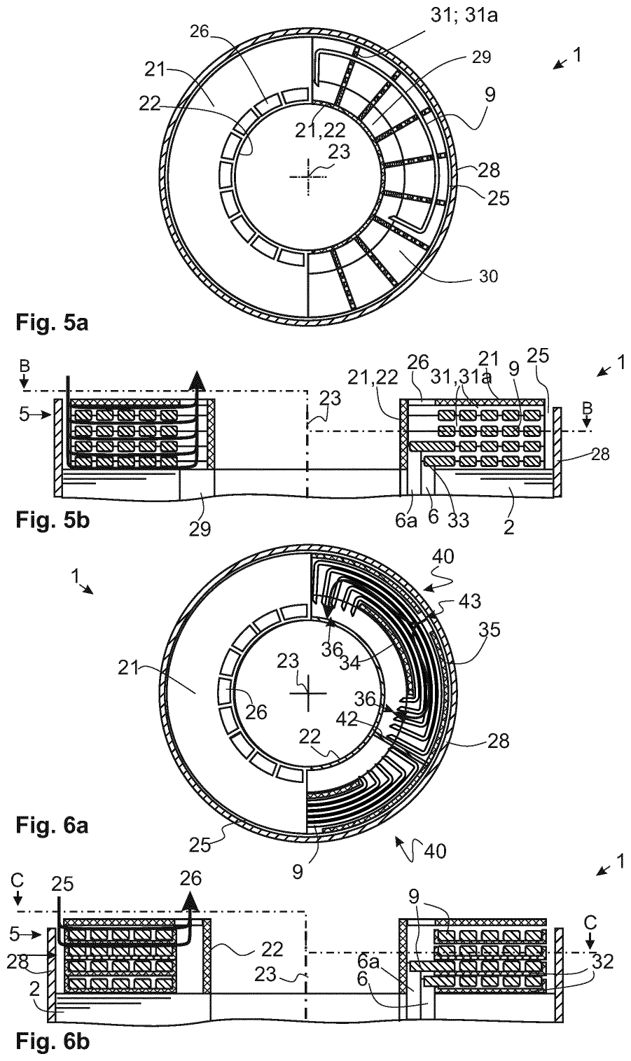

FIG. 5A shows a plan view of a stator according to FIG. 3 in a variant of the embodiment with exclusively radial partitions with a section in steps according to FIG. 5B;

FIG. 5B shows a cross-section along the axis of the stator of FIG. 5A explaining the view onto and into the cooling channel;

FIG. 6A shows a plan view of a stator according to FIG. 3 in a second variant of the embodiment with a section in steps according to FIG. 6B with connection levels and connection webs connected fluidically in parallel;

FIG. 6B shows a cross-section along the axis of the stator of FIG. 6A explaining the view onto and into the cooling channel;

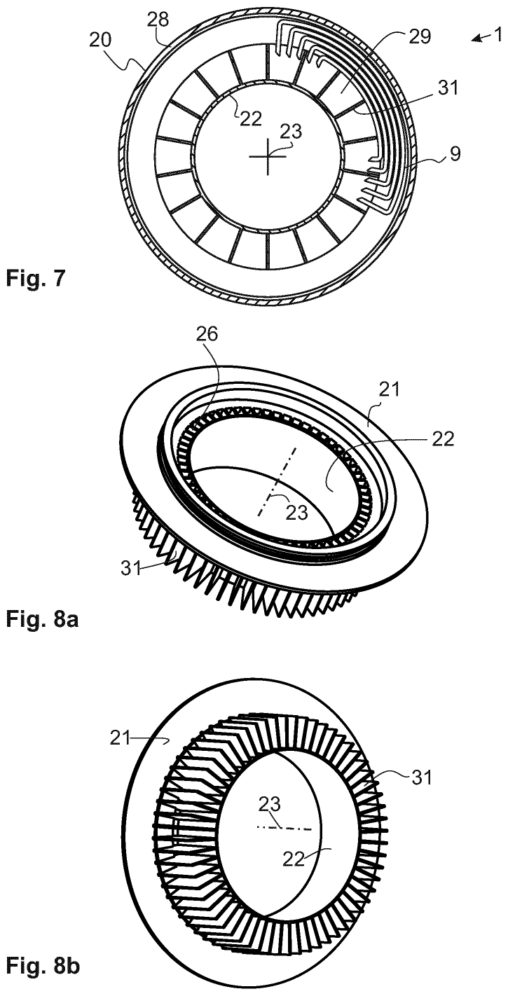

FIG. 7 shows a plan view onto a stator according to FIG. 3 for an embodiment of the fluid flow only in a groove area with radial partitions, without bar-type conductor, connection webs and cooling channel;

FIGS. 8A and 8B show perspective views of a cover unit for a winding head of a stator according to FIG. 7;

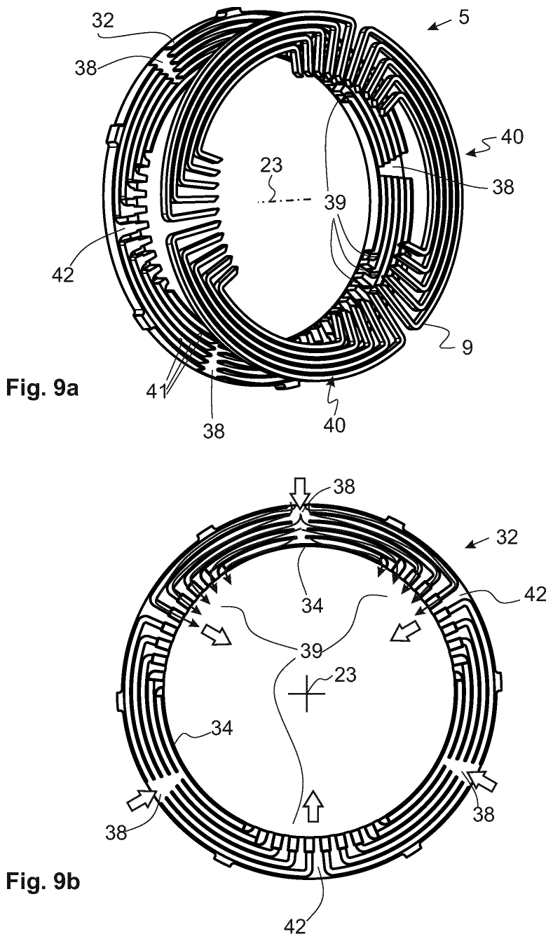

FIG. 9A shows an exploded view of an insulation ring of a cooling channel with connection web groups for an embodiment of the fluid flow for a winding head cooling of a stator according to FIG. 3 in a further variant of the embodiment only for the bridging area;

FIG. 9B shows a plan view onto the insulation ring shown in FIG. 9A;

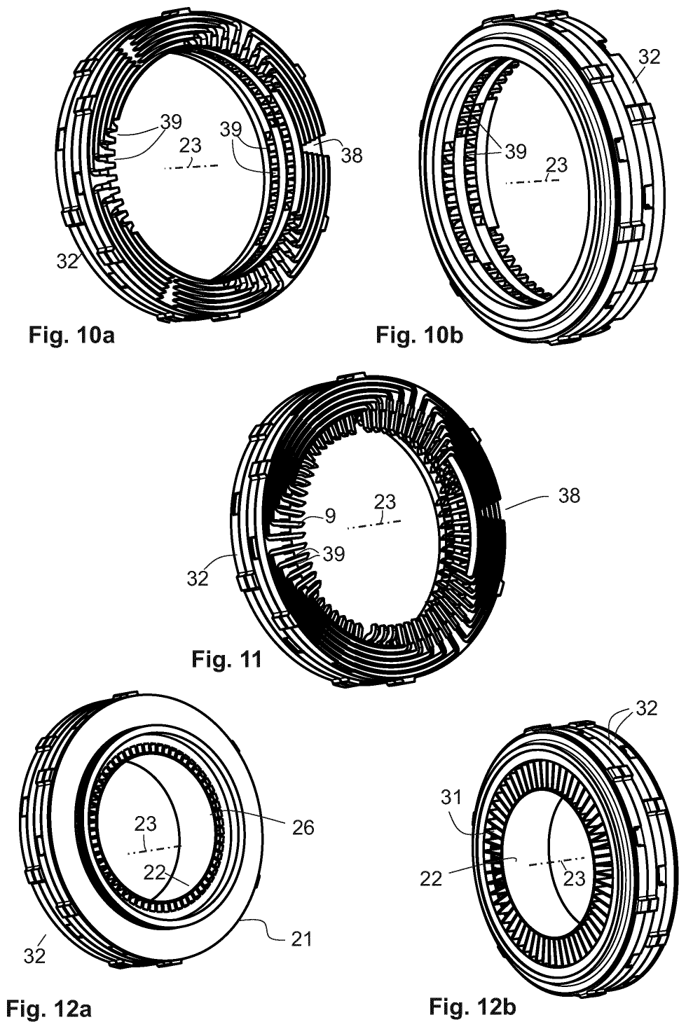

FIGS. 10A and 10B each show perspective views onto assembled insulation rings of a cooling channel without connection webs for a winding head cooling for a stator of FIG. 3 according to a preferred variant of the embodiment;

FIG. 11 shows the assembled insulation rings according to FIG. 10A or 10B, respectively, with connection webs;

FIGS. 12A and 12B show the assembled insulation rings according to FIGS. 10A and 10B, respectively, with a cover unit or lid;

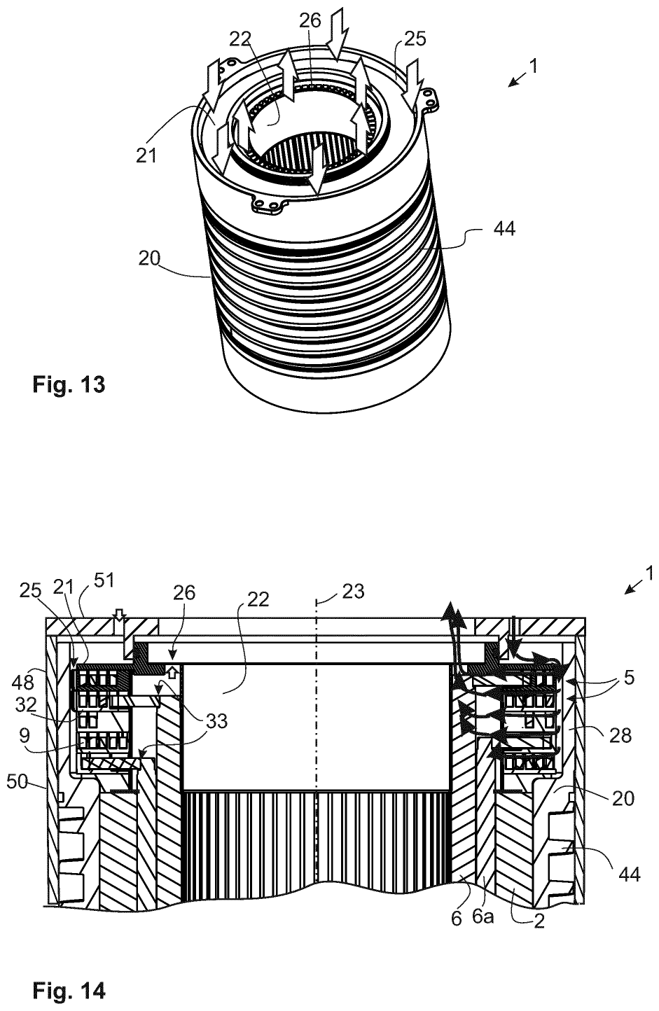

FIG. 13 shows a stator with a cooling channel according to the present invention and with plotted fluid flows according to the preferred variant of the embodiment;

FIG. 14 shows a longitudinal section through an upper part of a stator according to the preferred variant of the embodiment, in particular its winding head with the cooling channel according to the invention, where fluid flows are plotted;

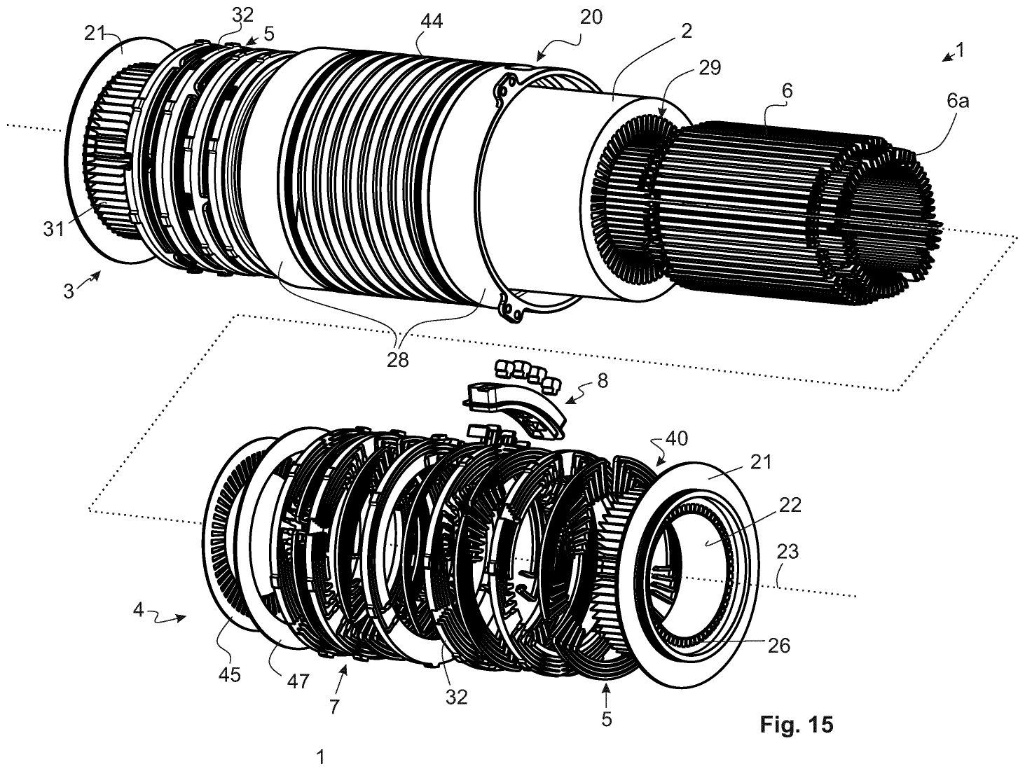

FIG. 15 shows an exploded view of a stator according to the invention with two winding heads and cooling channels according to the preferred variant of the embodiment; and

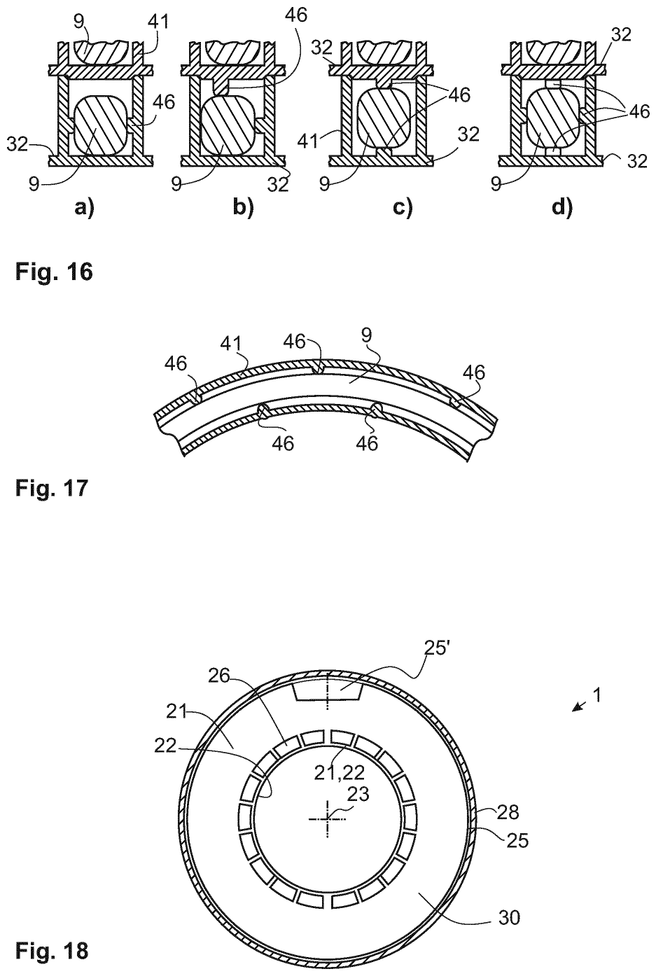

FIG. 16 shows four different construction variations of the partitions within a cooling channel with connection webs arranged therein;

FIG. 17 shows a construction variant for the arrangement of holding elements at partitions;

FIG. 18 shows a variant of a lid part with an enlarged inflow opening.

FIGS. 1 and 2 show a stator with a winding assembled from bar-type conductors and connection webs.

FIG. 1 shows a stator 1 with a cylindrical stator jacket or stator core stack 2 in which the elongate bar-type stator conductors 6 are arranged concentrically around the axis of the stator or stator jacket and within corresponding flutes or grooves, respectively, of the stator jacket 2. At each end of the stator 1, starting from the upper side or the bottom side of the stator jacket 2, a first winding head 3 (on side A) and a second winding head 4 (on side B) are formed.

Both winding heads 3, 4 each comprise connection levels 5 which are formed of connection webs 9. Here, one connection web 9 each connects two bar-type conductors 6 which extend from the stator jacket 2 into the winding head 3, 4. The winding head 4 differs from the winding head 3 in that in the winding head 4, a connection level 7 with three phase terminals 8 is additionally installed. The connection webs 9 are arched bar-type conductors with bar-type conductors additionally extending radially to the axis of the stator whose function is to electrically connect the bar-type conductors 6 in pairs. Here, the bar-type conductors 6 are connected to each other according to a predetermined pattern, which is why the distance as well as the number of the connection webs 9 formed as bar-type conductors between the bar-type conductors 6 connected in pairs is predetermined. The winding heads 3 and 4 have an annular or cylindrical design and are essentially formed by the connection levels 5 which are arranged concentrically and in parallel with respect to each other. The phase terminal 8 in said connection level 7 consists of three contacts, preferably for a three-phase current connection. The bar-type conductors 6 are designed such that they extend up to a certain connection level 5 in the winding head 3 and in the winding head 4. Thereby, these bar-type conductors 6 are associated with the same or different connection levels 5, and thus with certain connection webs 9, in order to realise a certain connection pattern.

FIG. 2 shows a side view of the stator of FIG. 1. The first winding head 3 comprises four connection levels 5, and the second winding head 4 comprises four connection levels 5 and one connection level 7 with the phase terminal 8. The connection levels 5 and 7, respectively, are all arranged perpendicularly to the central axis 23 of the stator 1, while the bar-type conductors 6 are arranged in parallel to this axis. The central axis 23 describes the axis of a rotor (not shown) insertable into the stator 1, and is simultaneously used to describe the geometrical properties of the elements of the stator 1, such as e. g. the stator jacket 2, the bar-type conductor 6, connection levels 5, etc., and to relate them with respect to each other.

FIGS. 3 and 4 show a winding head cooling for a stator of FIGS. 1 and 2, respectively, in a basic variant with a fluid inlet 25 shaped as an annular gap, and a fluid outlet 26 shaped as an annular gap.

FIG. 3 shows a cross-section through a stator 1 along the central axis 23, wherein, compared to FIGS. 1 and 2, the stator 1 shown here additionally comprises a cylindrical cooling housing/sleeve 20. The cooling housing 20 is integrally formed and comprises, in its central outer section, threaded cooling ribs 44 at which a cooling fluid, such as water, can flow, and outer rings 28 at the two end sections. The stator jacket 2 abuts inside against the cooling housing 20 and has essentially the same length as this section. Via the cooling housing, the stator can be cooled indirectly, that means without a direct fluid contact.

The winding head has a direct cooling, i. e. a cooling fluid, such as a dielectric oil, can be conducted through the winding head. The two winding heads 3 and 4 are located within the two outer rings 28 formed by the cooling housing. The winding heads 3 and 4 or their outermost connection level 5, respectively, are/is each protected against access to the housing 20 by an annular cover unit or lid ring 21 with an inner ring 22. The lid ring 21 forms, together with the outer ring 28, an annular gap 25 which serves as an inflow for a cooling fluid. The lid ring 21 forms, together with the inner ring 22, an annular gap 26 which serves as an outflow for a cooling fluid. Thus, both winding heads 3 and 4 each comprise an annular lid 21 with an inner ring 22 as a cover for the connection levels 5 and 7, respectively, with respect to the outer side. With reference to the cross-section of the stator 1, one can easily see that the bar-type conductors 6 and 6a are formed concentrically around the central axis 23 of the stator 1. Here, the bar-type conductors 6 and 6a are located in pairs within the same flutes of the stator jacket 2. The bar-type conductors 6a arranged inside or closer to the axis 23 are longer, compared to the bar-type conductors 6 arranged outside and preferably reach to the outermost connection levels of the winding heads 3 and 4. The housing 20 is at least partially formed of metal to permit a better cooling effect for a cooling fluid and the other elements of the stator 1.

FIG. 4A shows a section of the stator 1 according to section A-A of FIG. 3, wherein in particular the bar-type conductors 6 located between the inner ring 22 and the outer ring 28 and connected to each other in pairs via connection webs can be seen.

FIG. 4B schematically shows four annular areas or circles which appear between the inner ring 22 and the outer ring 28 of the stator according to FIG. 3 and FIG. 4A, respectively. The ring areas are introduced for a simple reference so that they can be referred to below. The inner and outer areas represent annular gaps 25, 26 for the inflow or outflow of the cooling fluid. The ring area 30 shows the area where the arched part of the connection webs 9 extends. It can be referred to as bridging area 30. The ring area 29 shows the ring area in which the bar-type conductors 6, 6a are arranged in the stator grooves and connected to the connection webs 9. It can also be referred to as groove area 29 or contacting area 29.

With FIGS. 5A, B and 6A, B, two different variations of a winding head cooling according to FIG. 3 are illustrated below.

FIGS. 5A, 5B show a first embodiment for a winding head cooling with exclusively radially arranged partitions 31. The winding consists of bar-type conductors 6, 6a, which are arranged in two layers within grooves of a core stack 2 (not shown in FIG. 6A) and are connected via connection webs 9 arranged in multiple layers (only rudimentally shown). The connection webs 9 are held by or in holding webs/holding clamps 31a attached regularly across the circumference. The holding clamps simultaneously form the radial partitions 31. The connection webs 9 of the individual connection layers 5 are not fluidically separated from each other horizontally—apart from the radially extending holding clamps.

The cooling fluid is uniformly introduced, via an annular gap 25, into the winding head and above and across the complete height thereof, is deflected by the radial partitions 31 towards the central axis 23, and subsequently exits from the winding head via the partially interrupted annular gap 26. Equal connection web sections thereby undergo an approximately equal admission of cooling medium and thus an approximately equal cooling.

In detail, FIG. 5A shows a stator analogous to FIG. 3 with a section B-B according to FIG. 5B with a partial cross-section, on the one hand of a cover element 21 and, on the other hand, of the partitions 31 of the cooling channel arranged vertically. On the upper side of the cooling channel, the cover unit 21 or lid, respectively, is arranged. The inner ring 22 and the outer ring 28 form the lateral delimitations of the cooling channel. The vertically arranged partitions 31 are radially arranged in abutment against the inner ring 22 and the lid 21. Between the lid ring 21 and the outer ring 28, an annular gap 25 is formed as an inflow for a cooling fluid. Between the lid ring 21 and the inner ring 22, an annular gap 26 is formed as an outflow, the inner annular gap 26 being interrupted by webs of the cover part 21. The partitions 31 are formed radially and in particular axially symmetrically to the central axis 23. By means of the partitions 31 and the lid 21, channels are formed which permit laminar fluid flows between the annular gap 25 and the annular gap 26.

FIG. 5B shows a cross-section along the axis of the stator of FIG. 5A explaining the view onto and into the cooling channel. The lid ring 21 is arranged on the winding head or on its uppermost connection level 5. Between the inner ring 22 and the lid ring 21, the annular gap outflow 26 is formed. Between the outer ring 28 and the lid ring 21, the annular gap outflow 25 is formed. Corresponding arrows are plotted on the left side of the cross-section and describe the flow. While in FIG. 5A, the vertical partitions 31 can be seen, in FIG. 5B, the partitions arranged perpendicular to the central axis 23 are indicated. Next to the bar-type conductors 6 and 6a, the connection points with the connection webs 9 where the two elements are connected to each other can be clearly seen.

FIGS. 6A and 6B show a second embodiment with cooling channels of a winding head analogous to FIG. 3, where the cooling channels are dually connected in parallel. The individual connection levels 5 are separated by horizontal insulation discs 32 on which the connection webs 9 are positioned. Within each connection level 5, the connection webs are combined into connection web groups 40, individual connection web groups being separated from each other by radial partitions 42. By arched partitions 34, 35, a cooling fluid flowing in or out via an annular gap 25 or 26, respectively, is brought onto paths along the longitudinal axes of the connection web.

In detail, FIG. 6A shows a plan view onto the stator 1 according to FIG. 3 with a partial cross-section (cf. section B-B in FIG. 6B), on the one hand of a cover element 21 and, on the other hand, of a connection level with connection webs 9. Moreover, in this case, no radially formed partitions 31, but the arched inner walls and outer walls 34 and 35 can be seen. On the left side, between the inner ring 22 and the cover element 21, radial elements or webs, respectively, can be seen which fix the ring 22 and the lid 21 to each other and are arranged in the area of the annular gap outflow 26. Between the inlet area 43 and the outlet areas 36 within the cooling channel, a split fluid flow forms between said walls. As can be seen in the plan view of the stator 1, the connection webs 9 are arranged in groups 40 of five in one ring sector each which is formed by radial partitions 42. The inlet area 43 can be designed as a throttle element, advantageously as a bore in the outer wall 35, to achieve a uniform fluid distribution between the various groups 40.

FIG. 6B shows a cross-section along the axis of the stator of FIG. 6A explaining the view onto and into the cooling channel. Again, the bar-type conductors 6 and 6A which are connected to the connection webs 9 can be seen. Equally, a fluid flow is plotted on the left side which flows from the annular gap inflow 25 through the cooling channel to the annular gap outflow 26. The cooling channel itself is annular and is essentially formed by the cover ring 21, the inner ring 22, the outer ring 28 and the lowermost insulation ring 32.

FIGS. 7 and 8 show a possible embodiment for the groove area 29 of an embodiment for a stator 1 according to the invention, wherein radial partitions of a cooling channel according to the invention are only formed in the groove area 29. The design of the fluid channel in the area of the bridging area is not determined.

FIG. 7 shows a plan view onto a stator 1 with a housing 20 and an outer ring 28 and an inner ring 22, however without the bar-type conductor. Analogous to previous examples, connection webs 9 are arranged in the front area of the stator core stack 2 to form an assembled winding. Radial partitions 31 are integrally formed with the inner ring.

FIGS. 8A and 8B show perspective views of a cover unit 21 for a winding head of a stator with an integrally connected inner ring 22, radially arranged partitions 31, and an annular gap outflow 26. The cover unit comprises an annular projection with an O-ring. The projection separates the inflow area from the outflow area in an assembled state, cf. FIG. 13.

FIGS. 9 to 11 show a possible embodiment for the bridging area 30 of an embodiment according to the invention. Here, individual connection webs 9 are accommodated in insulation discs or insulation rings 32, respectively, and separated from each other by arched partitions 41 such that a well-defined cooling channel is formed for each individual connection web 9. Thereby, a comparable cooling capacity is ensured for each connection web.

In detail, FIG. 9A shows an exploded view onto an insulation ring 32 of a cooling channel with a connection level 5 of three connection web groups 40 with five connection webs 9 each which can be arranged on the insulation ring 32 or the horizontal partition 32 in specially prefabricated flutes or recesses. The insulation ring 32 comprises three fluid inlets 38, i. e. one separate inlet for each connection web group, and for each connection web 9 two fluid outlets 39, i. e. ten outlets per connection web group 40 and thirty outlets 39 for the insulation ring 32. All outlets 39 are directed towards the centre of the ring 32.

For the connection webs 9 to be adequately arranged in the respective connection web group 40, intermediate walls 41 are formed between the connection webs 9 or on the insulation ring 32 which form the mentioned flutes. In addition, the connection web groups 40 are separated from each other by radial partitions 42. Thereby, a fluid flow can be split into parallel partial flows for each connection web group, and additionally, each partial flow can be split into further parallel partial flows for one connection web half each.

FIG. 9B shows a plan view onto the insulation ring shown in FIG. 32. In this figure, no connection webs 9 are arranged to better show the channels or flutes which are formed by the intermediate walls 41. Each flute is connected to the outside by a triangular inlet which extends from the inlet area 38 to an inner wall 34 and can thus be supplied with a cooling fluid. The cooling fluid entering through an inlet area 38 can flow out from ten different outlets 39 towards the central axis 23. This applies for each ring sector of a ring 32 or each connection web group 40 of a connection level 5. Instead of a continuous inlet area 38, the intermediate walls 41 and the outer wall 35, however, can also be non-interrupted and each comprise a radial bore as a fluid inlet. By the design of the bore, a pressure drop across each inlet area can be selectively adjusted, e. g. 100 mbar across the outer wall and 10 mbar across each intermediate wall. In particular in a lying operation of the stator, thereby a non-uniform distribution of cooling fluid across a plurality of connection web groups 40 and/or a plurality of connection levels 5 can be achieved.

FIGS. 10A and 10B each show perspective views of assembled insulation rings 32 of a cooling channel without connection webs. The four successively arranged insulation rings 32 each have three inlets 38 and thirty outlets 39.

FIG. 11 shows the assembled insulation rings according to FIG. 10A or 10B, respectively, with connection webs 9.

FIGS. 12A and 12B finally show a combination of the possible embodiments represented in FIGS. 9 to 11 and 7 to 8. The assembled insulation rings 32 according to FIGS. 10A and 10B, respectively, are provided with a cover unit or lid 21 analogous to FIG. 8. The lid unit 21 is equipped with an inner ring 22 and vertical partitions 31. The inserted connection webs are not visible in both these cases.

FIGS. 13 to 15 show a preferred embodiment for a stator cooling with a cooling channel according to the invention.

FIG. 13 shows a perspective view onto a stator 1 with a cooling channel according to the present invention and with plotted fluid flows. The stator 1 is formed with a cooling housing 20 and cooling ribs or a winding 44, respectively. On the upper side, the lid unit 21 with the inner ring 22 can be seen which form, in connection with the outer ring of the cooling housing 20, the annular gap inflow 25 and the annular gap outflow 26.

FIG. 14 shows a longitudinal section through an upper part of a stator 1, in particular its winding head with the cooling channel according to the invention, wherein fluid flows are plotted on the right side. Compared to the above-described stators, this embodiment is equipped with a fluid housing 48. The fluid housing 48 comprises a cylindrical outer wall 50 as well as an annular cover 51, for example a bearing shield. The outer wall 50 directly abuts against the cooling housing 20. The cover 51 is fixed to the outer wall 50 and comprises a plurality of openings for a fluid inflow and one opening for a fluid outflow and for a rotor. The fluid inflow is directed towards the lid unit 21 and presses it downwards, i. e. onto the stator jacket 2. The lid unit 21 is mounted to be axially movable. The lid unit separates the inflow and outflow areas by an annular projection with an enclosed O-ring. By the flow resistance for the cooling fluid being adjustable within great ranges by designing the individual inflows and fluid passages, in particular in the inflow to connection web groups, a contact force of the lid unit can be adapted, e. g. within a range of 150 to 250 mbar. By means of the enlarged cross-section along the longitudinal axis or central axis 23 of the stator 1, the stator jacket 2 with the bar-type conductors 6 and 6a as well as the winding head with the different connection webs 9, insulation rings 32, the lid unit 21 with the inner ring 22, and the annular gaps formed thereby for the inflow and outflow 25 and 26 can be clearly seen. The webs 9 and the conductors 6, 6a are connected to each other at the contact points 33, in particular welded to each other.

Altogether, this results in a multiply connected parallel fluid flow. By the annular gap inflow, the individual connection levels are fluidically connected in parallel. By the insulation discs, the individual connection webs or connection half webs are fluidically connected in parallel.

FIG. 15 shows an exploded view of a stator 1 according to the invention with two winding heads 3 and 4 and cooling channels. The stator 1 is equipped with a stator jacket 2, where in the flutes or groove area 29 formed on the inner side, the bar-type conductors 6 and 6a are arranged concentrically around the central axis 23. On the one side, the winding head 3 is arranged to connect the bar-type conductors 6 and 6a at one end with the corresponding connection webs 9. On the other side of the stator jacket 2, the other winding head 4 is arranged which differs from the first winding head 3 in that it comprises an additional connection level 7 with a phase terminal 8. Both winding heads 3 and 4 are arranged one upon the other with a sealing mat 45, an adapter piece 47, four connection levels 5 with the corresponding connection webs 9 or with three connection web groups 40 each, respectively. As a termination, a lid element 21 is provided which comprises an inner ring 22 and vertically arranged radial partitions 31.

FIG. 16 shows four different construction variations of the insulation rings 32, in particular their intermediate walls 41, within a cooling channel with connection webs 9 arranged therein. The intermediate walls 41 and the insulation rings 32 can comprise holding elements 46 in the form of naps or the like. In example a), the elements 46 are formed at the intermediate walls 41. In example b), the elements 46 are arranged at an intermediate wall 41 and at the bottom side of a ring 32. In example c), the elements 46 are simultaneously formed at the bottom side of the upper ring 22 and at the bottom side of the upper ring 32. In example d), the elements 46 are formed at both intermediate walls and the upper and bottom sides of the upper and bottom insulation rings 32, respectively, wherein the lateral elements 46 and the top/bottom elements 46 are not formed at the same height, but alternatingly along the longitudinal axis of the connection web 9, cf. FIG. 17.

FIG. 17 schematically shows in detail a connection web 9 held between two partitions 41. The connection web is here held by naps 46 arranged alternatingly. By the naps 46, an assembly of the connection web 9 is possible where it is subjected to bending and clamped.

FIG. 18 shows a variant of a stator according to the invention in a plan view with a lid part 17 with an enlarged inflow opening 25′. The enlarged inflow opening 25′ is formed as a recess at the lid 21. The inflow opening 25′ is attached to the top of the stator, the stator being operated in a lying arrangement. Gravity correspondingly acts from the top to the bottom in the plane of the drawing. Thereby, uniform fluid supply across the complete stator circumference can be achieved. In particular, the flow resistance can be reduced in the inflow in the upper area of the winding head. Thereby, a non-uniform fluid distribution, as it occurs as a consequence of fluid backing up in the antechamber of the winding head (between the lid 21 and the housing cover 51, cf. FIG. 14) and which occurs by the non-equal pressure distribution resulting from the hydrostatic pressure, can be avoided or reduced. Advantageously, thereby, even at very low pressures and/or at a very low flow rate, a uniform cooling of the complete winding head can be achieved.

At an only low fluid pressure, the fluid initially accumulates at the lowermost point of the antechamber. There, it cannot flow away as quickly as it is supplied due to the high flow resistance of the annular gap. The fluid level in the antechamber correspondingly increases up to the height of the enlarged inflow opening 25′. From there, it can, practically without any flow resistance, penetrate into the annular gap 25 behind it, where it uniformly flows along, for example, the outer circumference of insulation discs 32 and flows through individual inlet openings 38 to connection web groups 40 or connection webs 9, cf. FIG. 12b. The fluid inflow to the antechamber can be attached at any location.

### LIST OF REFERENCE NUMERALS

1 stator
2 stator jacket or stator core stack
3 winding head side A
4 winding head side B
5 connection level
6 bar-type conductor
6a bar-type conductor
7 connection level with phase terminal
8 phase terminal
9 connection webs/front connectors
20 cooling housing/sleeve
21 lid
22 inner ring
23 central axis
25 annular gap inflow
25′ enlarged inflow opening
26 annular gap outflow
28 outer ring
29 groove area/connection area
30 bridging area
31 partition, vertical
32 partition, horizontal, or insulation ring/disc
33 contact/welding of the bar-type conductor with the connection web
34 partition, arched inner wall
35 partition, arched outer wall
36 outlet areas
37 lid
38 inlet
39 outlet
40 connection web group
41 intermediate walls
42 partition between the connection web group
43 inlet area
44 winding/cooling ribs
45 sealing mat
46 nap/holding element
47 adapter piece/ring
48 fluid housing
50 outer wall of the fluid housing
51 cover of the fluid housing

1. Cooling channel for a winding head of an electrical machine, wherein, in order to conduct a cooling fluid, said cooling channel is designed with at least one inflow and at least one outflow, and is annular for provision around the winding head,
wherein the cooling channel has a plurality of partitions arranged such that parallel sub-channels are formed between the at least one inflow and at least one outflow, wherein the inflow is arranged radially outwardly, relative to the cooling channel, and the outflow radially inwardly, or the inflow is arranged radially inwardly, and the outflow radially outwardly.

2. Cooling channel according to claim 1,
wherein the inflow or the outflow is formed as an annular gap, wherein the inflow and the outflow are separated from each other by an annual top section of the cooling channel.

3. Cooling channel according to claim 1,
wherein at least some of the plurality of partitions are arranged radially and form radial partitions.

4. Cooling channel according to claim 1,
wherein at least some of the plurality of partitions are formed in a circular arc and arranged in particular in groups concentrically with respect to each other.

5. Cooling channel according to claim 1,
wherein at least some of the plurality of partitions comprise insulation rings arranged concentrically and in parallel with respect to each other.

6. Cooling channel according to claims 4,
wherein the radial partitions and the insulation rings are arranged perpendicularly with respect to each other.

7. Cooling channel according to claim 1,
wherein the partitions comprise fastening elements.

8. Cooling channel according to claim 1,
wherein the plurality of partitions is formed of an elastic material.

9. Cooling channel according to claim 1, wherein the cooling channel is formed in multiple pieces.

10. Cooling channel according to claim 9,
wherein the cooling channel comprises a sealing element as a bottom component and a stator cooling housing as an outer side wall.

11. Stator, in particular for an electric motor, with a plurality of bar-type conductors, wherein the stator comprises at least one cooling channel according to claim 1, and the partitions of the cooling channel are arranged between at least a part of the bar-type conductors.

12. Stator according to claim 11,
wherein the stator comprises a plurality of connection webs corresponding to the bar-type conductors.

13. Electrical machine with a cooling channel according to claim 1.

14. Cooling channel according to claim 1,
wherein the inflow and the outflow are formed as an annular gap, wherein the inflow and the outflow are separated from each other by an annual top section of the cooling channel.

15. Cooling channel according to claim 1,
wherein the partitions comprise clamping elements or naps.

16. Cooling channel according to claim 2,
wherein at least some of the plurality of partitions are arranged radially and form radial partitions.

17. Cooling channel according to claim 16,
wherein at least some of the plurality of partitions are formed in a circular arc and arranged in particular in groups concentrically with respect to each other.

18. Cooling channel according to claim 17,
wherein at least some of the plurality of partitions comprise insulation rings arranged concentrically and in parallel with respect to each other.

19. Cooling channel according to claims 18,
wherein the radial partitions and the insulation rings are arranged perpendicularly with respect to each other.

20. Cooling channel according to claim 19,
wherein the partitions comprise clamping elements or naps.
